(19) United States
(12) Patent Application Publication
(10) Pub. No.: US 2020/0200361 A1
(43) Pub. Date: Jun. 25, 2020

(54) Optical Lens for Illumination Purposes

(71) Applicant: Swareflex GmbH, Vomp (AT)

(72) Inventors: Daniel Hauser, Innsbruck (AT); Anton Flir, Vomp (AT); Walter Ebner, Vomp (AT)

(21) Appl. No.: 16/305,586

(22) PCT Filed: Jun. 1, 2017
(86) PCT No.: PCT/EP2017/063282

§ 371 Date: Nov. 29, 2018

(30) Foreign Application Priority Data
Jun. 4, 2016 (EP) 16173022.1

(51) Int. Cl. F21V 5/04; F21V 5/08; G02B 19/00

(52) U.S. Cl. CPC F21V 5/048; F21V 5/08; F21W 2131/101; G02B 19/0061; G02B 19/0028

(57) ABSTRACT

Optical lenses for illumination purposes (L) are proposed, comprising a lateral surface (C) and a light exit surface (B), wherein the underside is shapes in a plane fashion and has an optical relevant cutout for receiving a light source, which is distinguished by the fact that the lens (L) has a lateral surface (C) that is wholly reflectively coated, and has a light exit surface (B) having the two vertices (b1) and (b2), wherein (b1) and (b2) represent respectively the highest and lowest vertices upon the transition from the light exit surface (B) to the lateral surface (C).

### FIELD OF THE INVENTION

The invention relates to the field of traffic engineering, and relates to specifically designed lenses for use in illumination devices for tunnel systems, and to the illumination devices containing such lenses.

### PRIOR ART

The illumination of traffic tunnels is a challenge for optics design and lighting design because of strict illumination standards. In particular, the tunnel entry zone is critical, since the human eye has to adapt to the quickly changing light levels (adaptation). In addition, the perceived dazzling during the drive through a tunnel is an important factor, which is standardized by the authorities.

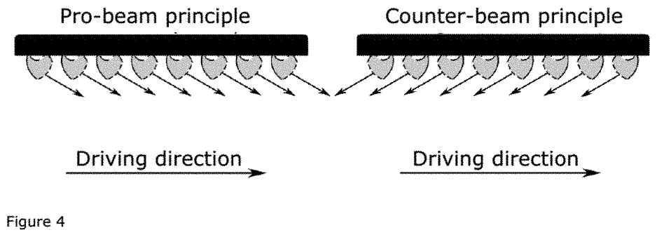

An illumination concept that has become established in recent years in the tunnel field is the so-called pro-beam and counter-beam principle. In the pro-beam principle, the projection of the main emission direction onto the road runs parallel to the direction of driving, while the projection is antiparallel to the direction of driving in the counter-beam principle. The functional principle is also shown in FIG. 4, in which the pro-beam principle is shown on the left, and the counter-beam principle is shown on the right.

The advantage of the pro-beam principle resides in a glare reduction of the luminaire, and in high contrast figures of merit. Pro-beam lighting is used, for example, in the passage in traffic tunnels. The counter-beam principle allows for a high luminous flux efficiency, which is specifically required in the tunnel entry zone. Thus, the number of luminaires and lamps can be reduced, and standard demands can be met more efficiently. In addition, the counter-beam principle is employed in the tunnel entry zone in order to produce the luminance profile desired for the adaptation of the eye.

Tunnel luminaires having different suitability criteria are already known from the prior art:

Thus, EP 2 093 484 B1 (Bartenbach) discloses tunnel lamps containing a heat buffer for buffering external, environmental or foreign, heat acting on the lamp, comprising a heat accumulator (2) with a phase changer whose phase transition temperature from solid to liquid and/or from liquid to gaseous is below the admissible working temperature limit of the lamp and above the normal working temperature of the lamp. Such a heat accumulator sort-of sucks in the heat acting on the lamp in case of a fire, whereby heating of the lamp or its components above the respectively admissible temperature limit is prevented. However, the document does not contain any disclosure directed to the design of an optical lens.

In contrast, EP 2 565 525 B1 (Bartenbach) describes lamps in which the lenses are arranged in an exposed manner and respectively have a cusp-shaped marginal elevation on one side on the side of the lenses opposed to the driving direction, which is provided on its exterior side with a reflective coating acting towards the inside, has an elevation above the base area of the lens of at least 125% of the maximum elevation of the remaining body of the lens, and captures scattered light emitted by contaminations on the light-emitting surface of the lens against the driving direction substantially completely.

EP 2 112 428 B1 (Bartenbach) relates to a street, especially tunnel, lamp having an asymmetrical luminance distribution. The luminous flux of the lamp is limited to a half space that is behind the lamp as seen in the driving direction. The lamp possesses a hidden space that includes the half space that is in front of the lamp as seen in the driving direction. Because of the illumination of the tunnel or the road zone in the driving direction, vehicles running in front of a particular vehicle are illuminated virtually from behind, so that they are clearly visible to the following driver. On the other hand, freeness from dazzling is achieved by avoiding glare from the half space oriented against the driving direction.

EP 2 962 998 A1 (Swareflex) also relates to tunnel lenses that are characterized by having a light-emitting surface in an ellipsoid-like free shape, in which the bottom sides have a planar shape and are provided with an optically relevant recess for receiving a light source, and the lenses consist of a glass with a specific composition and a defined refractive index.

Optical units for illumination purposes are known from U.S. Pat. No. 7,799,509 B1 and WO 2012/080889 A1.

Optical systems with asymmetrical light distributions have the advantage that they enable well adapted light distributions. The previous approach is a transparent free-shape lens, also with a cover hood and/or partial mirroring of the lateral surface in order to produce the desired light distributions. However, the prior art has considerable problems: Thus, in particular, part of the luminous flux is absorbed by the cover hood, whereby the efficiency of the lamp decreases to below 60%. The partial mirroring of the lateral surface is also disadvantageous, because a complex lens shape must be used in order to obtain the desired light deflection onto the mirrored surface. Further, the partial mirroring of individual bounded lateral surfaces have a negative effect on the ability to produce the optical system. Finally, the light distributions produced are highly dependent on production tolerances. In general, previous optical systems have the disadvantage that their light distributions do not have the optimum precision and thus lead to luminous flux losses or disturbing dazzling.

These disadvantages often complicate or prevent the use of such optical concepts in traffic tunnels.

Therefore, the object of the present invention has been to provide an alternative illumination concept for tunnels that completely overcomes the above described drawbacks of the prior art. In particular, all of the following partial objects should be achieved at the same time:
use of simple geometric basic forms;
simple production, with respect to both the lens body and the coating;
minimization of Fresnel losses while the light yield is enhanced;
minimization of the perceived emitting surface area;
reduction of dazzling in the pro-beam principle;
increases luminous flux efficiencies in both the pro-beam and the counter-beam principle;
possibility to achieve any desired asymmetric light distributions;
smaller “color-over-angle” effect (light emitted at a narrow angle is white to blueish, while light emitted at a broad angle has a yellow or yellow-red tinge. This phenomenon is referred to as “color-over-angle” (CoA)), and
easy dropping off of residual liquids.

### DESCRIPTION OF THE INVENTION

In a first aspect, the invention relates to optical lenses for illumination purposes (L), comprising a lateral surface (C) and a light-emitting surface (B), wherein the bottom side (A) has a planar shape and possesses an optically relevant recess for receiving a light source, characterized in that said lens (L)
(a) has a lateral surface (C) that is wholly coated with a reflective coating, and
(b) has a light-emitting surface (B) with the two vertices (b1) and (b2), in which (b1) and (b2) are respectively the highest and lowest vertices in the transition from the light-emitting surface (B) to the lateral surface (C).

The “lateral surface” means the outer surface of the shaped lens body, which borders the light-emitting surface and the planar bottom surface.

In other words, the lateral surface represents the outer surface of the shaped lens body without the light-emitting surface and without the planar bottom surface with its light entry surface.

The lenses are further characterized in that the light-emitting surface (B) has either a planar or a curved design. If the surface is planar, then the basic surface (B1) of the light-emitting surface and the light-emitting surface (B) are the same. In contrast, if the surface has a curved design, i.e., a concave convex or concavo-convex shape, then the basic surface (B1) of the light-emitting surface and the plane tangential to the light-emitting surface (B) are parallel to one another.

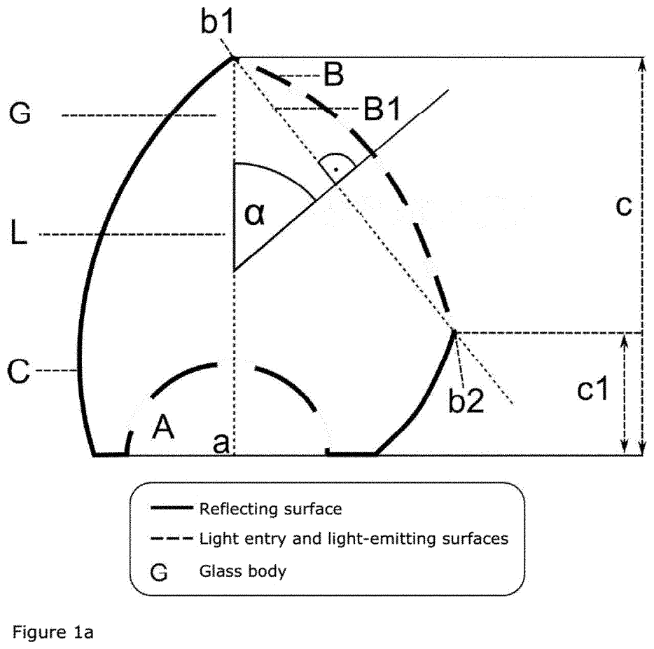

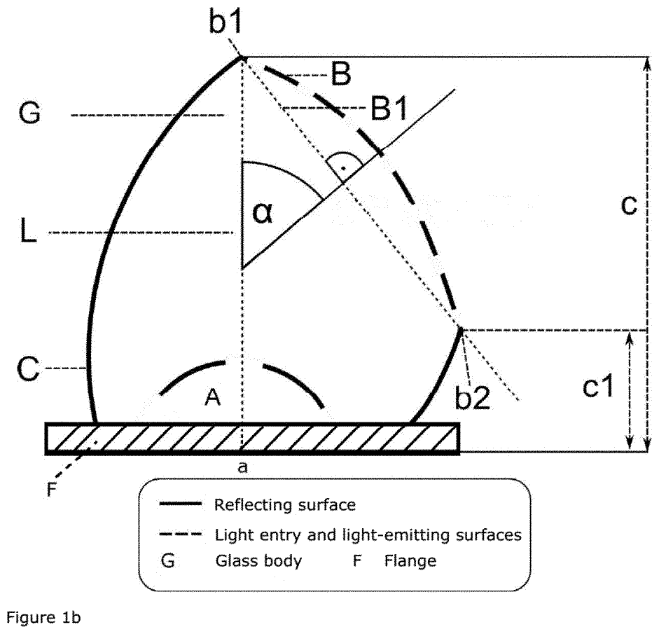

The lenses not necessarily have a symmetrical design when viewed from a side (which means a view onto the edge of the basic surface B1). This means, for example, that the side having the light-emitting surface may be broader than the other side. This is also illustrated in FIG. 1, for example. Similarly, it is also possible that both sides have equal widths, or that the side that does not have the light-emitting surface is the broader one. In a preferred variant, the side having the light-emitting surface is the broader one when viewed from the side.

In addition, the lenses according to the invention may have mounting aids on their bottom side in some embodiments. Such mounting aids may be known mounting aids in principle. In preferred embodiments, these may be flaps or, in particular, one or more positive-locking connection elements. In some embodiments, it is particularly preferred that the lenses according to the invention have a positive-locking connection element on the bottom side thereof in the form of a flange circumferential to the lens.

The optical lenses according to the present invention that have mounting aids on the bottom side thereof correspondingly have an outer surface extension of the bottom side.

In such embodiments, the lateral surface is limited on the downside by the edges of the mounting aids. Accordingly, the reflecting surface is also limited by the edges of the mounting aids. In the case where said mounting aids are several mounting aids in the form of flaps or the like, the lateral surface C is both above the respective upper edges of the flaps and in the interior spaces between the corresponding flap edges. In the case where said positive-locking connection element is a flange, the reflecting surface of the lateral surface C, or the lateral surface C, extends to the upper edge of the flange.

The embodiments of the present invention in which the lenses according to the invention have mounting aids on the bottom side thereof have different advantages.

One important advantage is the fact that a better attachment is achieved with such mounting aids. The increased bottom contact surface of the lenses according to the invention increases the available adhesive surface. Accordingly, the adhesion of the lenses according to the invention onto the support is also improved.

In addition, it is advantageous to have a larger adhesive surface, because the adhesive may be applied further outside, i.e., more remote from the recess for receiving a light source, in the basic surface of the lenses according to the invention in this case; this can prevent (or at least clearly reduce) the event that adhesive flows into the recess or that volatile components, especially of the adhesive, get into the recess. Accordingly, the risk of soiling of or damage to the light source and/or light entry surface of the lenses is minimized or excluded.

In addition, it is advantageous that in the case where the lenses are embedded in a casting composition, the lenses according to the invention are anchored better (more firmly) in the casting composition. This increases the stability of the corresponding assembly considerably.

Of course, it is also possible that the lenses according to the invention are mechanically connected with the support through the mounting aids in addition to or in place of the adhesive bonding; preferred possibilities for this are screws or rivets. However, other possible mechanical connections, such as clamps, may also be employed.

The optically relevant recess for receiving the light source is a curved light-entry surface that is incorporated with a concave or concavo-convex shape into the lens body; accordingly, it may also be referred to as a curved light-entry surface incorporated with a concave or concavo-convex shape into the lens body. A light-entry surface with a concavo-convex curvature has zones with concave and convex curvatures, respectively. In a preferred variant, the curved light-entry surface has an elliptical shape.

In other embodiments, the light-entry surface does not have a curved design, but is, for example, planar, angular, square or the like; however, it must be ensured that sufficient light can enter into the lens.

In a preferred embodiment, the lenses according to the present invention have a curved light-entry surface, which may be elliptical, have a reflecting lateral surface, preferably one coated with a reflective coating, and a planar or curved light-emitting surface, which may be inclined. The shape of the lens system is preferably reduced to simple geometric basic forms. In particular, the production of the optical system with a small number 2) of simply parameterized surfaces and solids results in a lens shape that is easy to process in production. The limitations in the design of the light distribution because of the simple basic form of the lens are compensated for by the fully coated reflecting marginal surface. Thus, a light beam can be reflected at the marginal surface with a high efficiency at any angle of incidence without being based on the TIR effect. For unlike with TIR lenses (TIR=total internal reflection), the light yield according to the present invention is higher because Fresnel losses do not occur when light is reflected at the lens margin. In addition, a light beam can be reflected at any angle of incidence without being based on the TIR effect. This results in further degrees of freedom in the design of the light distribution. Also, in contrast to TIR systems, a so-called “frustrated total reflection” cannot occur, which is why the light power is coupled into bounding media.

In a variant of the present invention, the lenses consist of one piece of lens body, and optionally the coating.

Also, because of the fully coated coating or preferably mirroring and the fact that the light source is at least partially covered thereby, the perceived emitting surface is clear as compared to classical lens systems. This offers the possibility of an almost perfect avoidance of dazzling in the pro-beam principle, and high light flux efficiencies in pro-beam and counter-beam lamps, in which the fully coated mirroring is not a problem to common coating methods. It is possible to coat the lateral surface, i.e., the outer surface of the lens molded part, only in certain regions, namely in those regions in which the light emitted by the luminaire is not subject to total reflection anyway within the lens body and thus cannot pass through the lateral side.

Finally, the efficiency of light bundling is higher as compared to lens systems with covers, whereby standard requirements can be met more easily.

In addition, the angles of inclination of the light-emitting surface as well as of the whole glass body can be varied highly, in order to deflect the beams of the light source and to produce the desired light distribution. The relative position of the light-entry surface to the rest of the lens system can be additionally utilized in order to modify the light distribution further. These degrees of freedom enable any asymmetrical light distributions to be produced, which are not possible with classical lens systems, or only so with high losses. For the light bundling, the curvatures of the light entry and light-emitting surface as well as of the lateral surface are decisive. Further, the relative position and size of the cross-section of the light-emitting surface play an important role in light bundling. In addition, if at least a partial area of the surface or the entire surface is facetted, particularly homogeneous light distributions can be achieved.

Another advantage of the present invention resides in the fact that the so-called “color-over-angle” effect can be controlled more easily by means of the novel lens. This results in better conditions in the use of illumination if color gradients are undesirable.

In particular, the shaping of the lens also offers the possibility to build in a dropping-off edge, which is of advantage in traffic, in particular. Because of the beveling of the light-emitting surface, possible liquid residues flow to the edge region of the optical system, which is uncritical in terms of light technology, and drop off therefrom. This reduces the formation of soil residues, which can have a negative effect on the efficiency and the light distribution.

### Detailed Description of the Lenses

The lenses according to the invention are illustrated in FIGS. 1a and 1b. The reference signs have the following meanings:

A=planar bottom side with recess for the light source

B=light-emitting surface

B1=basic surface of the light-emitting surface

C=reflecting surface =lateral surface

L=lens body

a=center of the curved light entry surface

b1=vertex of the lens body and upper limit of the light-emitting surface

b2=lower limit of the light-emitting surface

c=elevation of the lens body

c1=elevation of the lens body down to which the light-emitting surface reaches

c2=difference between c and c1 (not shown)

α (alpha)=angle of inclination

Reflecting surfaces are shown by solid lines.

Light entry and light-emitting surfaces are shown by dashed lines.

The glass body is shown in gray.

The light-emitting surface itself preferably has the shape of an ellipse, in a specific case the shape of a circle. Preferably, the lenses have an elevation, as measured from the planar basic surface (A) to the vertex (b1), of about 0.5 to about 10 cm, preferably about 1 cm to about 5 cm, especially from about 2 to about 3 cm. However, this surface can have any more complicated design, for example, by including or excluding edges in or from the surface.

The basic surface of the light-emitting surface can be interpreted as an inclined section through the lens body starting from the vertex (b1) of the lens and reaching down to the point (b2) and down to an elevation (c1) that corresponds to about 5% to about 75%, preferably about 10% to about 50%, and especially about 15% to about 25% of the total elevation (c) of the lens. In particular, this surface has an inclination, or this section has an angle, that is α. The angle of inclination a of the basic surface is the angle between the normal of the basic surface (B1) and the normal of the planar bottom side (A). A positive angle α is formed by a rotation to the right in the direction of the vertex (b2), a negative angle is formed by a rotation to the left, i.e., towards the vertex (b1). The angle of inclination a ranges from −90° to +90°. Preferably, the angular range a is about −45° to about +45°, especially from 0 to about +30°.

FIG. 1b differs from FIG. 1a only by the fact that a flange is now shown in the lower part. In this figurative representation, the light entry surface is in part concealed by the represented flange (on the level of the lens's basic surface). The lateral surface C leads to the upper end of the flange.

The inclination of the basic surface influences the main direction of emission. The curvature of the light-emitting surface influences the light distribution. The angle of inclination of the basic surface, α, and the curvature of the light-emitting surface can be adapted to the illumination requirements.

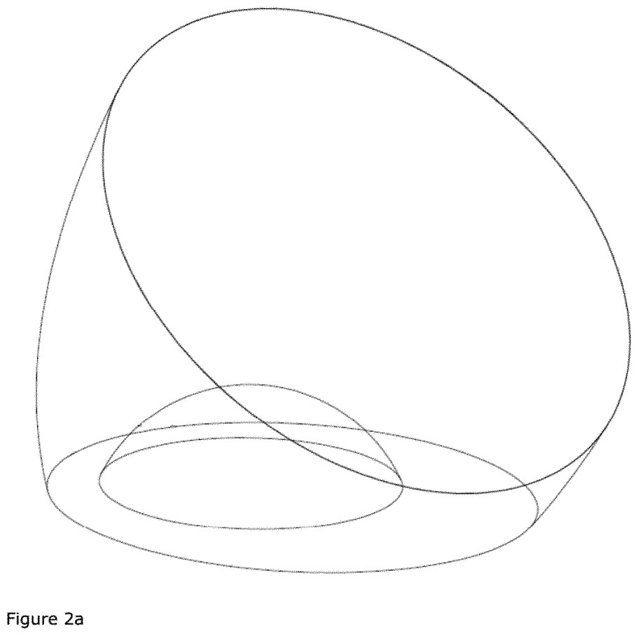

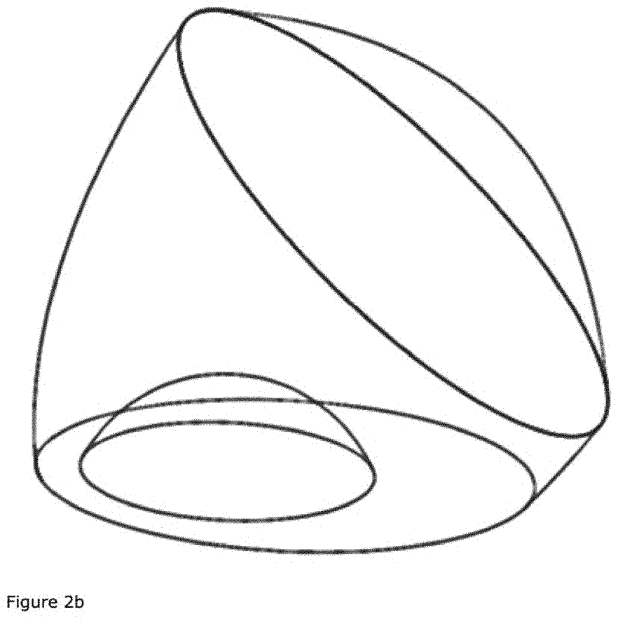

FIG. 2a shows a wire scaffold sketch of a lens according to the invention, in which the curved surface above the basic surface B1 of the light-emitting surface cannot be seen because of the perspective.

FIG. 2b shows a wire scaffold sketch of a lens according to the invention, in which the curved surface above the basic surface B1 is shown.

### Lens Body and Coating

The lens body can basically be made of any light-permeable polymer that can be coated. Preferably, however, they are glass bodies, because the latter are characterized by a particularly precise light incidence while the resistance is high at the same time.

The nature of the coating may also be of a wide variety, starting from an aluminum evaporation through coating with silver, gold or other metals. However, it is recommended to perform the coating, or to adjust the layer thickness, in such a way that a reflectance of at least 80%, preferably at least 90%, and in particular, at least 95%. Possible coating methods include, for example, wet-chemical processes, but also CVD, PVD, or especially sputtering.

### Light Sources

The light sources in this connection can be LED, OLED, LET or OLET; laser illumination is also possible.

LEDs, also referred to as light-emitting diodes, are light-emitting semiconductor devices whose electrical properties correspond to those of a diode. If an electric current flows through the diode in the forward direction, it emits light, IR radiation to UV radiation with a wavelength that depends on the semiconductor material and the doping thereof.

High-performance light-emitting diodes (H-LED) are operated with currents higher than 20 milliamperes. This results in particular requirements for heat dissipation, which express themselves in specific constructions. The heat can be dissipated through the current supply lines, through the reflector trough, or through heat conductors incorporated into the light-emitting diode body.

Further suitable LED embodiments that can be employed as light sources within the meaning of the present invention include the direct wire bonding of the light-emitting diode chip on the board (chip on board), and later casting with silicone compositions.

The LEDs employed as light sources may also be multicolored. Multicolored light-emitting diodes consist of several (two or three) diodes in one external body. They mostly have a common anode or cathode and one lead for every color. In an embodiment having two leads, two light-emitting diode chips are connected in antiparallel sense. Depending on polarity, one diode or the other will light up. A virtually continuous color change can be realized through a variable pulse-to-width ratio of a suitable alternating current.

Another possible light source within the meaning of the invention is OLEDs. These are organic light-emitting diodes, more precisely light-emitting thin-film devices made of organic semiconductor materials, which differ from inorganic light-emitting diodes in that the electric current density and luminous density are lower, and no monocrystalline materials are required. Therefore, as compared to conventional (inorganic) light-emitting diodes, organic light-emitting diodes can be produced at lower cost by thin-film technology. OLEDS are made of several organic layers. Mostly, a hole transport layer (HTL) is applied to the anode consisting of indium-tin oxide (ITO), which is present on a glass plate. Depending on the preparation method, a layer of PEDOT/PSS is often applied between the ITO and HTL, which serves to lower the injection barrier for holes and prevents the in-diffusion of indium into the junction. A layer that either contains the dye (about 5-10%) or, rather unfrequently, completely consists of the dye, for example, aluminum tris(8-hydroxyquinoline), Alq3, is applied to the HTL. This layer is referred to as emitter layer (EL). To this emitter layer, an electron transport layer (ETL) is optionally applied as well. Finally, a cathode consisting of a metal or an alloy with a low work function, such as calcium, aluminum, barium, ruthenium, magnesium-silver alloy, is deposited thereon under high vacuum. Mostly, a very thin layer of lithium fluoride, cesium fluoride or silver is vapor-deposited between the cathode and E(T)L as a protective layer, and to reduce the injection barrier for electrons.

Corresponding transistors, which are referred to as LETs or OLETs, may also be used instead of the light-emitting diodes.

The light sources are applied to or inserted into a suitable support. Optionally, more than one light source may be employed, for example, 5, 10, 15, 20 or more if needed, which are arranged either in rows or in circles. Above each light source, one of the inventive lenses is attached, wherein the recess in the lens is adapted to the light source. Such recesses usually have an elliptical basic surface, preferably a circular one, but can basically any other shape as well. The fixation is effected by adhesive-bonding the lens to the support, wherein the circumferential edge formed by the rest of the bottom side remaining around the bottom side provides a better hold and at the same time prevents moisture from entering. Preferably, the lenses are cast with the assembly consisting of the support and light source by means of, for example, epoxy resin.

### INDUSTRIAL APPLICABILITY

The present invention further relates to an illumination device, comprising

(a) at least one optical lens according to the present invention;

(b) at least one light source; and

(c) a support for receiving the light source(s) and lens(es).

In order to integrate the lenses in lamps in a mechanically stable manner, various supports or fixation techniques are employed. Mostly in classical optical systems, part of the light flux is absorbed and/or deviated. This can result in lower efficiencies and changed light distributions of the lamp. Because of the lateral surface that is wholly coated with a reflective coating, the novel lens system is completely independent of effects of this kind, which results in an increase in efficiency of the overall lamp.

In one embodiment of the present invention, the support respectively has at least one aeration hole in immediate proximity to the light source(s) and within the basic surface(s) of the recess(es) of the optical lens(es) according to the invention, through which volatile components that may be derived from the adhesive bonding of the lenses on the support, for example, can diffuse out of the lens recess(es). This has several advantages, including the fact that the surface of the light source and/or of the lens according to the invention can be prevented thereby from being soiled and/or damaged by a reaction with the volatile components.

In another embodiment, the illumination device comprises a wide variety of lenses arranged on the support, preferably lenses being arranged in a regular array.

Typical embodiments include illumination devices that comprise about from 1 to 200, preferably from 1 to 60, more preferably about 10, lenses; however, illumination devices with even more lenses are also possible.

In a preferred embodiment, the light-emitting surfaces B of all lenses on the support are oriented in the same direction. However, for other applications, it is also possible to orient the light-emitting surfaces B in different directions, optionally in groups or individually.

The present invention also further relates to a process for illumination, comprising the following steps:

(a) providing at least one illumination device as described above;

(b) mounting said at least one illumination device; and

(c) connecting said at least one illumination device to a power supply.

The process relates to the illumination of a wide variety of objects, such as streets, airports, ports, industrial plants, playgrounds and sports facilities. In particular, it is suitable for illuminating tunnels. The mounting can be effected in any suitable way, for example, on rooftops, walls, poles or cranes. In the case of tunnel illumination, the elements are incorporated into the ceilings or at a suitable height into the walls, which may optionally be inclined. Incorporation into existing power strips is also possible.

The invention finally relates to the use of the optical lenses according to the invention or of the illumination device containing them, on the one hand, for the illumination of, for example, streets, airports, ports, industrial plants, playgrounds and sports facilities, and especially of tunnels, and on the other hand, for illuminating areas homogeneously.

### EXAMPLES

### Example 1

### Comparative Examples C1 to C3

In order to further work out the differences of the novel optical system, light-technological simulations of three classical lenses and the novel lens system were performed. The simulation set-up is identical for all lens systems and is structured as follows:

1. Placing the LED into the origin of coordinates.

2. Setting the lens CAD geometry.

3. Adjusting the reference coordinates of the LED lens system.

4. Acquiring the light intensity distribution in polar coordinates.

5. Placing a rectangular area detector at a constant distance and with a constant size to calculate the luminous density distribution.

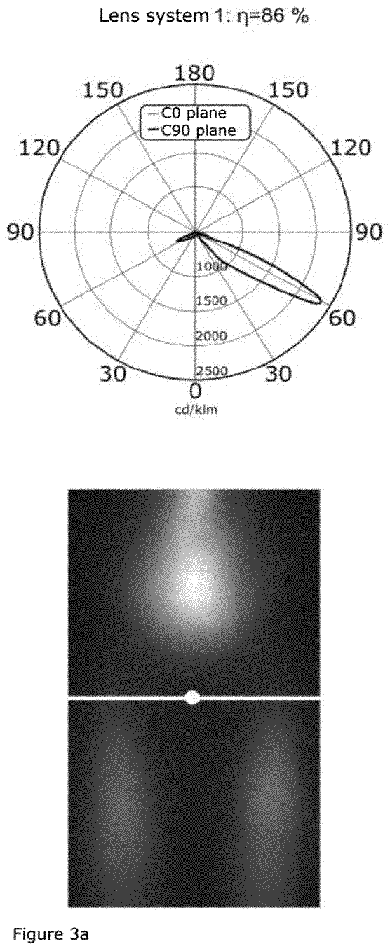

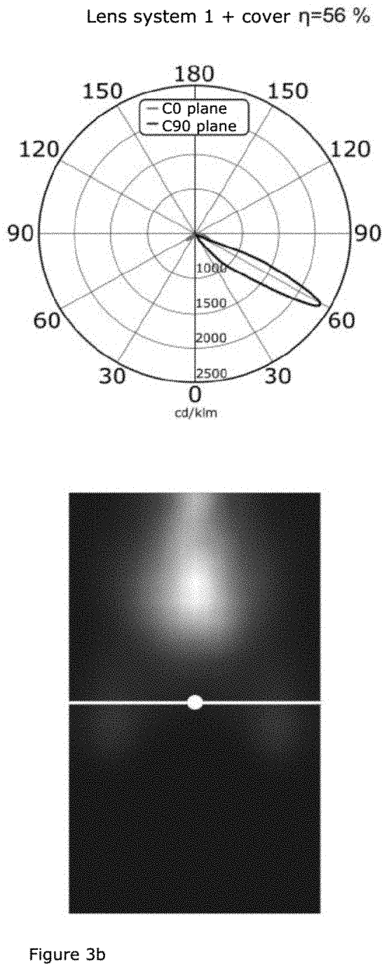

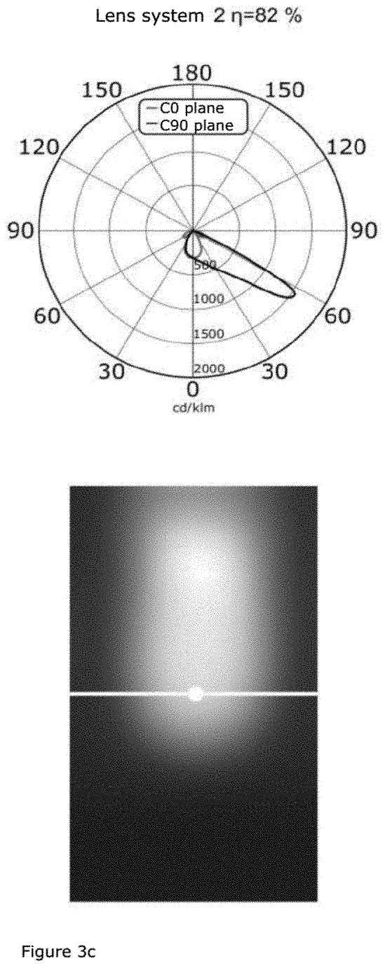

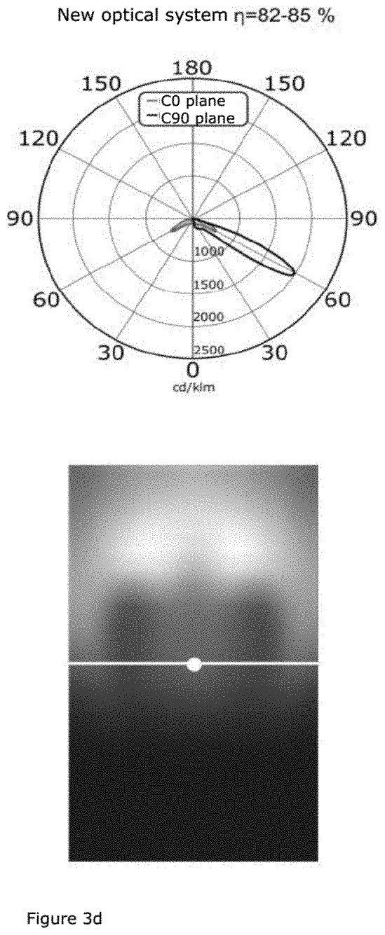

FIG. 3 shows the results of the light-technological simulation of the different optical systems. Lens system 1 (FIG. 3a) and lens system 1 with a cover (FIG. 3b) are existing lens systems that are employed in traffic. The lens system 2 (FIG. 3c) represents a simulation concept of a pure lens optical system, which narrowly misses prescribed standard requirements in traffic, and in addition is difficult to produce. FIG. 3d represents the novel optical system.

The optical efficiency of the lens systems is designated as In the upper halves of FIGS. 3a to 3d, the light intensity distribution curves are shown, and the luminous density distributions are shown in the lower halves. The horizontal lines mark the separation between minor and major emission planes of the lenses. The point in the center of the luminous density distribution represents the position of the lens. The absolute brightness of the luminous density distributions is normalized to the respective maximum luminous density for each Example.

Lens system 1 has an optical efficiency of η=86%.

Lens system 1 with a cover has an optical efficiency of η=56%.

Lens system 2 has an optical efficiency of η=82%.

The optical system according to the invention has an optical efficiency of η=82-85%.

The results of the light-technological examination of the four optical systems as represented in FIGS. 3a to 3d illustrate the advantage of the present invention. Significantly less light is projected into the rear image plane. As compared to lens system 1 with a cover, a similar amount of light arrives at the rear image plane, but the efficiency is higher by up to 30% because of the reflecting lateral surface of the new design. In contrast to classical single lens systems, the novel optical system enables the production of substantially more efficient lamps, which additionally are able to produce a more asymmetrical light distribution.

1. An optical lens for illumination purposes comprising a bottom side (A) having a planar shape and possessing an optically relevant recess for receiving a light source, wherein said optical lens (L)
(a) has a lateral surface (C) that is wholly coated with a reflective coating, and
(b) has a light-emitting surface (B) with two vertices (b1) and (b2), in which (b1) and (b2) are respectively the highest and lowest vertices in the transition from the light-emitting surface (B) to the lateral surface (C).

2. The optical lens according to claim 1, wherein the bottom side (A) includes a mounting aid.

3. The optical lens according to claim 1, wherein the light-emitting surface (B) has a planar design.

4. The optical lens according to claim 1, wherein the light-emitting surface (B) has a curved design.

5. The optical lens according to claim 3, wherein a basic surface (B1) of the light-emitting surface and the light-emitting surface (B) are the same.

6. The optical lens according to claim 4, wherein a basic surface (B1) of the light-emitting surface and a plane tangential to the light-emitting surface (B) are parallel to one another.

7. The optical lens according to of claim 1, wherein the optical lens has an elevation (c), as calculated from a center (a) of the bottom side (A) to the vertex (b1) of the optical lens, of about 0.5 cm to about 10 cm.

8. The optical lens according to claim 1, wherein a basic surface (B1) starts from the vertex (b1) of the optical lens and reaches down to the vertex (b2) and down to an elevation (c1) that corresponds to about 5% to about 75% of an elevation (c) of the optical lens.

9. The optical lens according to claim 1, wherein a basic surface (B1) has an angle α spanning between the normal of the basic surface (B1) and the normal of the bottom side (A) that ranges from −90° to 90°.

10. The optical lens according to claim 9. wherein the angle α ranges from −50° to +50° or from 0 to 45°.

11. The optical lens according to claim 1, wherein the light source is an LED or an OLED.

12. An illumination device, comprising
(a) at least one optical lens for illumination purposes according to claim 1;
(b) at least one light source; and
(c) a support for receiving the light source(s) and lens(es).

13. A process for illumination, comprising the following steps:
(a) providing at least one illumination device according to claim 12;
(b) mounting said at least one illumination device; and
(c) connecting said at least one illumination device to a power supply.

14. (canceled)

15. The process of claim 13. wherein the at least one illumination device illuminates areas homogeneously.
